(19) United States
(12) Patent Application Publication
(10) Pub. No.: US 2015/0274068 A1
(43) Pub. Date: Oct. 1, 2015

(54) Illuminated Seat Cover Assembly

(71) Applicant: Carlos D. Falconi, Secaucus, NJ (US)

(72) Inventor: Carlos D. Falconi, Secaucus, NJ (US)

(21) Appl. No.: 14/227,850

(22) Filed: Mar. 27, 2014

(51) Int. Cl. B60Q 3/02; B60N 2/60

(52) U.S. Cl. CPC B60Q 3/0223; B60N 2/60; B60Q 3/0203

(57) ABSTRACT

An illuminated seat cover assembly for decorating a vehicle seat with illumination includes a panel that is positionable on the vehicle seat. The panel comprises a top sheet that has a plurality of light apertures extending therethrough. a user sits on the top sheet when the user sits on the vehicle seat. A medial sheet is coupled to the top sheet. A strip is coupled to the medial sheet. A plurality of light emitters is coupled to the strip. The plurality of light emitters emits light through the plurality of light apertures. The light is visible to the user.

### BACKGROUND OF THE DISCLOSURE

### Field of the Disclosure

The disclosure relates to seat cover devices and more particularly pertains to a new seat cover device for decorating a vehicle seat with illumination.

### SUMMARY OF THE DISCLOSURE

An embodiment of the disclosure meets the needs presented above by generally comprising a panel that is positionable on the vehicle seat. The panel comprises a top sheet that has a plurality of light apertures extending therethrough. A user sits on the top sheet when the user sits on the vehicle seat. A medial sheet is coupled to the top sheet. A strip is coupled to the medial sheet. A plurality of light emitters is coupled to the strip. The plurality of light emitters emits light through the plurality of light apertures. The light is visible to the user.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of a illuminated seat cover assembly according to an embodiment of the disclosure.

FIG. 2 is a perspective view of an embodiment of the disclosure.

FIG. 3 is an in-use view of an embodiment of the disclosure.

FIG. 4 is an alternative in-use view of an embodiment of the disclosure.

FIG. 5 is a schematic view of an embodiment of the disclosure.

### DESCRIPTION OF THE PREFERRED EMBODIMENT

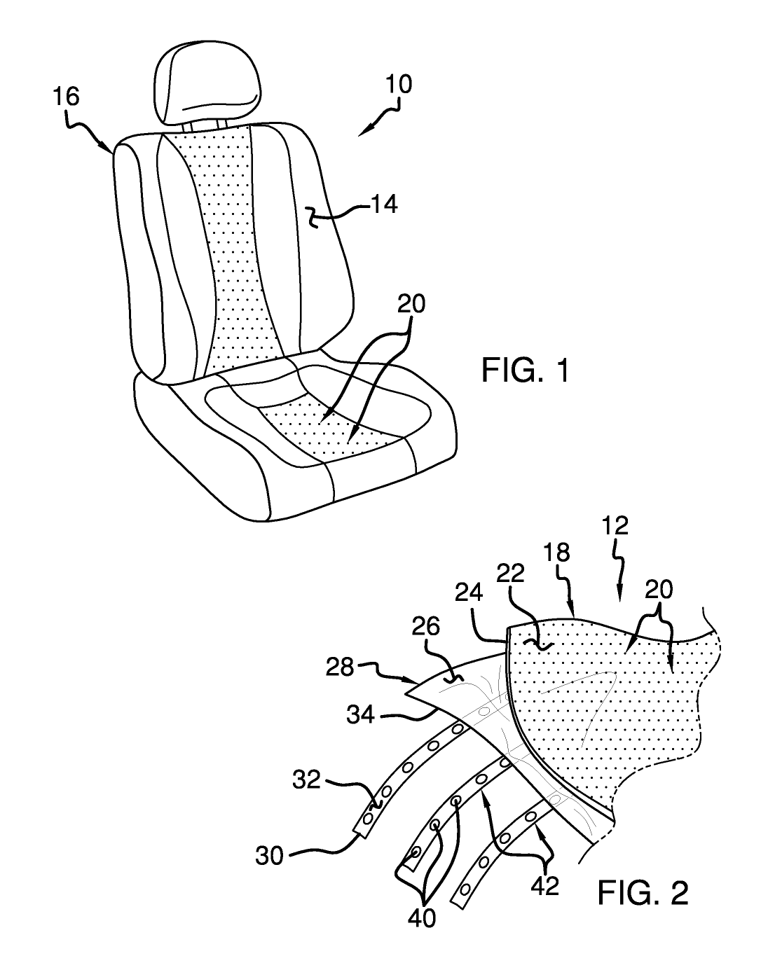

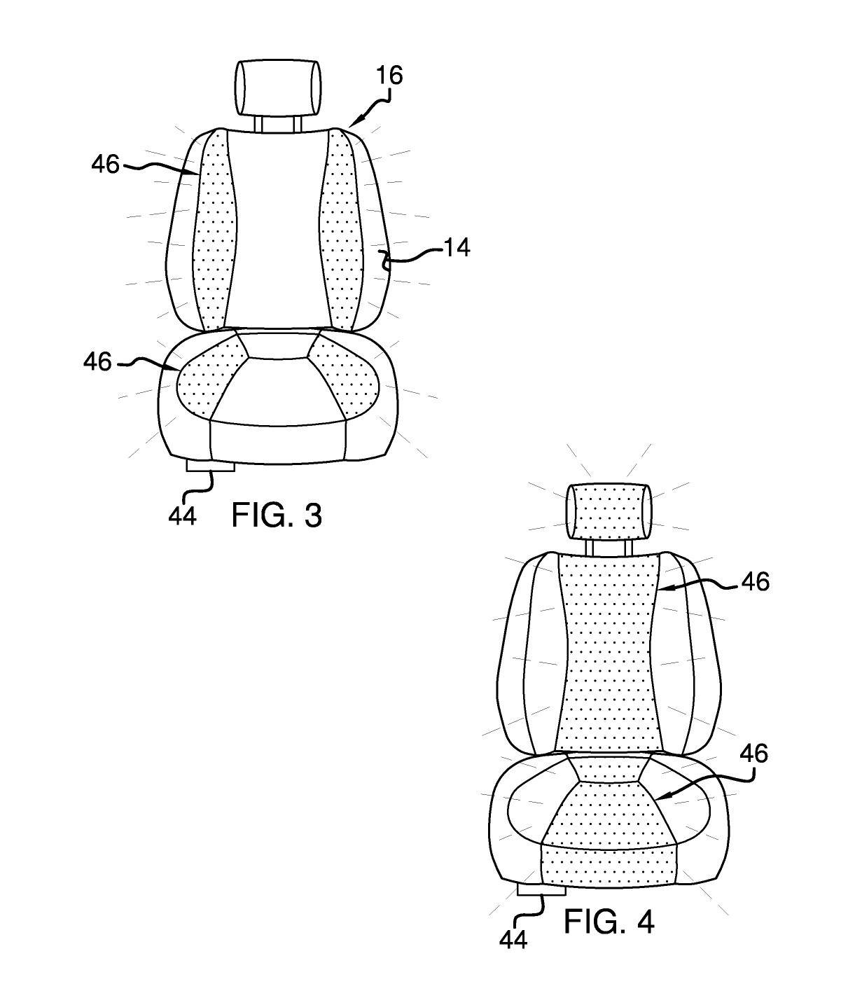

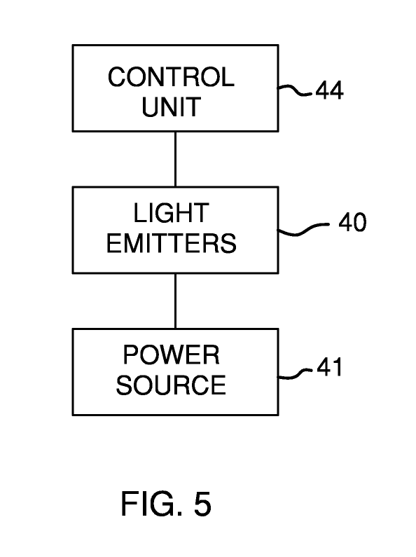

With reference now to the drawings, and in particular to FIGS. 1 through 5 thereof, a new illuminated seat cover device embodying the principles and concepts of an embodiment of the disclosure and generally designated by the reference numeral 10 will be described.

As best illustrated in FIGS. 1 through 5, the illuminated seat cover assembly 10 generally comprises a panel 12 coupled to an outer surface 14 of a vehicle seat 16. The panel 12 is exposed on the vehicle or to an interior of the vehicle. The vehicle seat 16 may be a vehicle seat 16 of any conventional design. Additionally, the panel 12 may be comprised of a flexible material.

The panel 12 comprises a top sheet 18 that has a plurality of light apertures 20 extending through a top surface 22 and a bottom surface 24 of the top sheet 18. The plurality of light apertures 20 is evenly spaced apart and distributed across an entire width and length of the top sheet 18. A user sits on the top sheet 18 when the user sits in the vehicle seat 16. The top sheet 18 may be comprised of a non-transparent material.

An upper surface 26 of a medial sheet 28 is coupled to the bottom surface 24 of the top sheet 18. The medial sheet 28 is coextensive with the top sheet 18. Additionally, the medial sheet 28 may be comprised of a translucent material. The upper surface 26 of the medial sheet 28 is textured.

A strip 30 is provided. The strip 30 is elongated. A topmost surface 32 of the strip 30 is coupled to a lower surface 34 of the medial sheet 28. The strip 30 extends along an entire length of the medial sheet 28. Additionally, the strip 30 may be comprised of a flexible material.

A plurality of light emitters 40 is coupled to the strip 30. The plurality of light emitters 40 is evenly spaced apart and distributed along an entire length of the strip 30. The plurality of light emitters 40 emits light through the plurality of light apertures 20. The light is visible to the user. Lastly, the plurality of light emitters 40 may each comprise an LED of any conventional design.

The plurality of light emitters 40 is electrically coupled to a power source 41. The power source 41 may be the vehicle electrical system. The strip 30 is one of a plurality of the strips 42. The plurality of strips 42 is evenly spaced apart and distributed along an entire width of the medial sheet 28. The textured upper surface 26 of the medial sheet 28 diffuses the light emitted by the plurality of light emitters 40 so the light is evenly distributed along the entire upper surface 26 of the medial sheet 28.

A control unit 44 is coupled to the vehicle seat 16. The control unit 44 is electrically coupled to the plurality of light emitters 40. The control unit 44 controls a rate at which the plurality of light emitters blinks and a color of the light emitted by the plurality of light emitters 40. Finally, the control unit 44 may be an electronic light control unit of any conventional design.

In use, the panel 12 is cut to a selected shape. The panel 12 is coupled to the vehicle seat 16 in the convention of seat upholstery. Additionally, the panel 12 is cut into a plurality of sections 46. Each of the plurality of sections of the panel 46 is coupled to a selected area of the vehicle seat 16. The plurality of sections of the panel 46 is arranged in any selected pattern or organization on the vehicle seat 16. The user adjusts the control unit 44 to selected one of a plurality of preset blinking patterns of the plurality of light emitters 40. Finally, the user adjusts the control unit 44 to select one of a plurality of preset colors of the light emitted by the plurality of light emitters 40.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An illuminated seat cover assembly configured to cover a vehicle seat, said assembly comprising:
a panel being positionable on the vehicle seat, said panel comprising;
a top sheet having a plurality of light apertures extending therethrough;
a medial sheet coupled to said top sheet, said medial sheet allowing transmission of light therethrough;
a strip coupled to said medial sheet; and
a plurality of light emitters coupled to said strip, said plurality of light emitters emitting light through said plurality of light apertures such that the light is visible to the user.

2. The assembly according to claim 1, wherein said panel being coupled to an outer surface of the vehicle seat such that said panel is exposed to an interior of the vehicle.

3. The assembly according to claim 1, wherein said plurality of light apertures extending through a top surface and a bottom surface of said top sheet.

4. The assembly according to claim 3, wherein said plurality of light apertures being evenly distributed on said top sheet such that said plurality of light apertures completely covers said top sheet.

5. The assembly according to claim 1, wherein an upper surface of said medial sheet being coupled to a bottom surface of said top sheet such that said medial sheet is coextensive with said top sheet.

6. The assembly according to claim 1, wherein said strip being elongated, a topmost surface of said strip being coupled to a lower surface of said medial sheet.

7. The assembly according to claim 1, wherein said strip extends along an entire length of said medial sheet.

8. The assembly according to claim 1, wherein said plurality of light emitters being evenly spaced apart and distributed along an entire length of said strip.

9. The assembly according to claim 1, wherein said plurality of light emitters being electrically coupled to a power source.

10. The assembly according to claim 1, wherein said strip being one of a plurality of said strips.

11. The assembly according to claim 10, wherein said plurality of strips being evenly spaced apart and distributed along an entire width of said medial sheet.

12. The assembly according to claim 1, wherein a control unit is coupled to the vehicle seat.

13. The assembly according to claim 12, wherein said control unit being electrically coupled to said plurality of light emitters.

14. The assembly according to claim 13, wherein said control unit controlling a rate at which said plurality of light emitters blinks and a color of the light emitted by said plurality of said light emitters.

15. An illuminated seat cover assembly configured to cover a vehicle seat, said assembly comprising:
a panel coupled to an outer surface of the vehicle seat such that said panel is exposed to an interior of the vehicle, said panel comprising;
a top sheet having a plurality of light apertures extending through a top surface and a bottom surface of said top sheet, said plurality of light apertures being evenly distributed on said top sheet such that said plurality of light apertures completely covers said top sheet;
an upper surface of a medial sheet being coupled to a bottom surface of said top sheet such that said medial sheet is coextensive with said top sheet, said medial sheet allowing transmission of light therethrough;
a strip being elongated and coupled to said medial sheet, said strip extending along an entire length of said medial sheet;
a plurality of light emitters coupled to said strip, said plurality of light emitters being evenly spaced apart and distributed along an entire length of said strip, said plurality of light emitters emitting light through said plurality of light apertures such that the light is visible to the user, said plurality of light emitters being electrically coupled to a power source;
said strip being one of a plurality of said strips, said plurality of strips being evenly spaced apart and distributed along an entire width of said medial sheet; and
a control unit coupled to the vehicle seat, said control unit being electrically coupled to said plurality of light emitters, said control unit controlling a rate at which said plurality of light emitters blinks and a color of the light emitted by said plurality of said light emitters.
